(19) United States
(12) Patent Application Publication
(10) Pub. No.: US 2018/0150081 A1
(43) Pub. Date: May 31, 2018

(54) SYSTEMS AND METHODS FOR PATH PLANNING IN AUTONOMOUS VEHICLES

(71) Applicant: GM GLOBAL TECHNOLOGY OPERATIONS LLC, Detroit, MI (US)

(72) Inventors: DREW GROSS, SAN FRANCISCO, CA (US); GABRIEL WARSHAUER-BAKER, MOUNTAIN VIEW, CA (US); BENJAMIN WEINSTEIN-RAUN, SAN FRANCISCO, CA (US); ERIC LUJAN, SAN FRANCISCO, CA (US)

(73) Assignee: GM GLOBAL TECHNOLOGY OPERATIONS LLC, Detroit, MI (US)

(21) Appl. No.: 15/878,655

(22) Filed: Jan. 24, 2018

(51) Int. Cl. G05D 1/02; G05D 1/00; G06N 5/04; G06F 17/30

(52) U.S. Cl. CPC G05D 1/0221; G06F 17/30958; G06N 5/045; G05D 1/0088

(57) ABSTRACT

Systems and method are provided for controlling a vehicle. In one embodiment, a method of path planning includes receiving sensor data relating to an environment associated with a vehicle, and defining, with a processor, a region of interest and an intended path of the vehicle based on the sensor data. The method further includes determining a set of predicted object paths of one or more objects likely to intersect the region of interest; determining, with a processor, a first candidate path that minimizes a first cost function applied to a spatiotemporal decision-point graph constructed based on the predicted object paths; determining, with a processor, a second candidate path that minimizes a second cost function applied to a state lattice graph constructed based on the predicted object paths; and determining a selected path from the first and second candidate paths based on a set of selection criteria.

### TECHNICAL FIELD

The present disclosure generally relates to autonomous vehicles, and more particularly relates to systems and methods for path planning in an autonomous vehicle.

### BACKGROUND

An autonomous vehicle is a vehicle that is capable of sensing its environment and navigating with little or no user input. It does so by using sensing devices such as radar, lidar, image sensors, and the like. Autonomous vehicles further use information from global positioning systems (GPS) technology, navigation systems, vehicle-to-vehicle communication, vehicle-to-infrastructure technology, and/or drive-by-wire systems to navigate the vehicle.

While recent years have seen significant advancements in autonomous vehicles, such vehicles might still be improved in a number of respects. For example, it is often difficult for an autonomous vehicle to quickly determine a suitable path (along with target accelerations and velocities) to maneuver through a region of interest while avoiding obstacles whose paths might intersect with the region of interest within some predetermined planning horizon. Such scenarios arise, for example, while taking an unprotected left turn, maneuvering around a double-parked car, merging into oncoming traffic, and the like.

Accordingly, it is desirable to provide systems and methods for path planning in autonomous vehicles. Furthermore, other desirable features and characteristics of the present invention will become apparent from the subsequent detailed description and the appended claims, taken in conjunction with the accompanying drawings and the foregoing technical field and background.

### SUMMARY

Systems and method are provided for controlling a first vehicle. In one embodiment, a method of path planning includes: receiving sensor data relating to an environment associated with a vehicle; defining, with a processor, a region of interest and an intended path of the vehicle based on the sensor data; determining a set of predicted object paths of one or more objects likely to intersect the region of interest; determining, with a processor, a first candidate path that minimizes a first cost function applied to a spatiotemporal decision-point graph constructed based on the predicted object paths; determining, with a processor, a second candidate path that minimizes a second cost function applied to a state lattice graph constructed based on the predicted object paths; and determining a selected path from the first and second candidate paths based on a set of selection criteria.

A system for path planning for a vehicle in accordance with one embodiment includes a region of interest module, with a processor, configured to determine a region of interest and an intended path of the vehicle based on the sensor data, and determine a set of predicted object paths of one or more objects likely to intersect the region of interest; a first candidate path determination module that minimizes a first cost function applied to a spatiotemporal decision-point graph constructed based on the predicted object paths; a second candidate path determination module that minimizes a second cost function applied to a state lattice graph constructed based on the predicted object paths; and a path selection module configured to determine a selected path from the first and second candidate paths based on a set of selection criteria.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle including a path planning system, in accordance with various embodiments;

FIG. 2 is a functional block diagram illustrating a transportation system having one or more autonomous vehicles as shown in FIG. 1, in accordance with various embodiments;

FIG. 3 is functional block diagram illustrating an autonomous driving system (ADS) associated with an autonomous vehicle, in accordance with various embodiments;

FIG. 4 is a dataflow diagram illustrating a path planning system of an autonomous vehicle, in accordance with various embodiments;

FIG. 5 is a flowchart illustrating a spatiotemporal decision point control method for controlling the autonomous vehicle, in accordance with various embodiments;

FIG. 6 is a top-down view of an intersection useful in understanding systems and methods in accordance with various embodiments;

FIG. 7 illustrates a region of interest corresponding to the intersection illustrated in FIG. 6, in accordance with various embodiments;

FIG. 8 presents a path planning visualization corresponding to the region of interest of FIG. 7, in accordance with various embodiments;

FIG. 9 depicts the path-planning visualization of FIG. 8 including obstacle regions, in accordance with various embodiments;

FIG. 10 depicts the path-planning visualization of FIG. 9 including decision points, in accordance with various embodiments;

FIG. 11 illustrates a directed graph corresponding to the decision points of FIG. 10, in accordance with various embodiments;

FIG. 12 depicts another example path-planning visualization, in accordance with various embodiments;

FIG. 13 illustrates a directed graph corresponding to the decision points of FIG. 12, in accordance with various embodiments; and

FIG. 14 is a flowchart illustrating a lattice-based control method for controlling the autonomous vehicle, in accordance with various embodiments;

FIG. 15 illustrates an example lattice to be used in connection with a lattice-based control method, in accordance with various embodiments;

FIG. 16 is a flowchart illustrating a method for combining lattice-based and spatiotemporal decision point control methods, in accordance with various embodiments;

FIGS. 17 and 18 present additional scenarios and regions of interests, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning models, radar, lidar, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

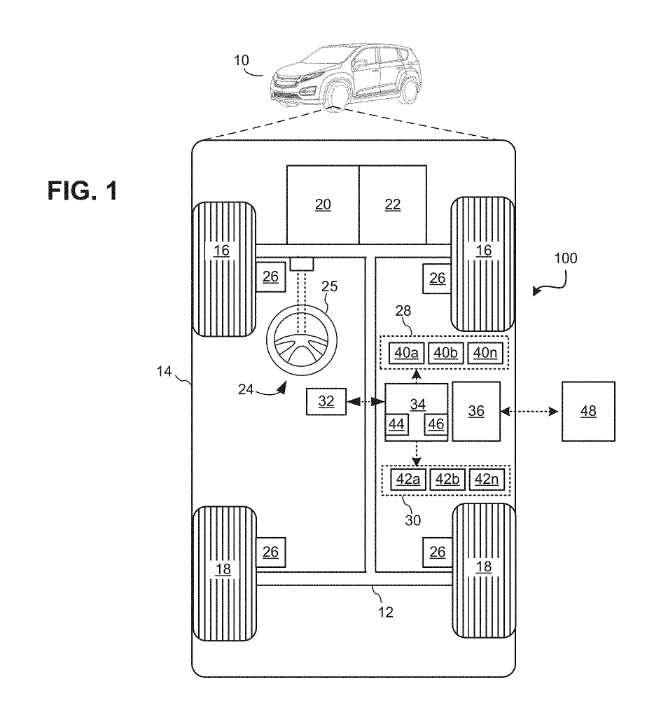

With reference to FIG. 1, a path planning system shown generally as 100 is associated with a vehicle (or “AV”) 10 in accordance with various embodiments. In general, path planning system (or simply “system”) 100 allows for selecting a path for AV 10 by combining the outputs of multiple path planning systems. In one embodiment, one of the path planning systems employs a spatiotemporal decision graph, or “trumpet” solver, while another employs a lattice-based graph (based, for example, on discretized values of acceleration). A path selection module is then used to decide the best path to select from the two path planning systems.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the path planning system 100 is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, etc., can also be used.

In an exemplary embodiment, the autonomous vehicle 10 corresponds to a level four or level five automation system under the Society of Automotive Engineers (SAE) “J3016” standard taxonomy of automated driving levels. Using this terminology, a level four system indicates “high automation,” referring to a driving mode in which the automated driving system performs all aspects of the dynamic driving task, even if a human driver does not respond appropriately to a request to intervene. A level five system, on the other hand, indicates “full automation,” referring to a driving mode in which the automated driving system performs all aspects of the dynamic driving task under all roadway and environmental conditions that can be managed by a human driver. It will be appreciated, however, the embodiments in accordance with the present subject matter are not limited to any particular taxonomy or rubric of automation categories. Furthermore, systems in accordance with the present embodiment may be used in conjunction with any vehicle in which the present subject matter may be implemented, regardless of its level of autonomy.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences a position of the vehicle wheels 16 and/or 18. While depicted as including a steering wheel 25 for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10 (such as the state of one or more occupants). Sensing devices 40a-40n might include, but are not limited to, radars (e.g., long-range, medium-range-short range), lidars, global positioning systems, optical cameras (e.g., forward facing, 360-degree, rear-facing, side-facing, stereo, etc.), thermal (e.g., infrared) cameras, ultrasonic sensors, odometry sensors (e.g., encoders) and/or other sensors that might be utilized in connection with systems and methods in accordance with the present subject matter.

The actuator system 30 includes one or more actuator devices 42a-42n that control one or more vehicle features such as, but not limited to, the propulsion system 20, the transmission system 22, the steering system 24, and the brake system 26. In various embodiments, autonomous vehicle 10 may also include interior and/or exterior vehicle features not illustrated in FIG. 1, such as various doors, a trunk, and cabin features such as air, music, lighting, touch-screen display components (such as those used in connection with navigation systems), and the like.

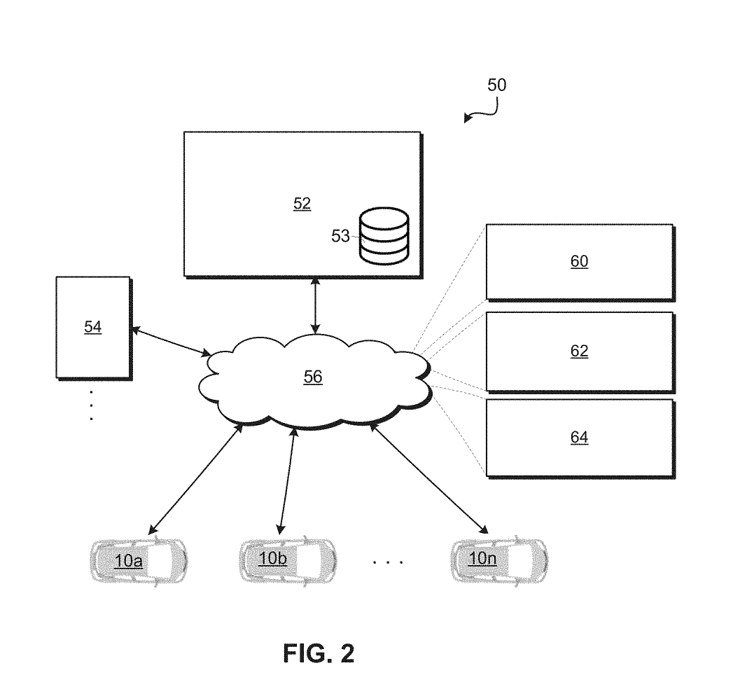

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. Route information may also be stored within data storage device 32—i.e., a set of road segments (associated geographically with one or more of the defined maps) that together define a route that the user may take to travel from a start location (e.g., the user's current location) to a target location. As will be appreciated, the data storage device 32 may be part of the controller 34, separate from the controller 34, or part of the controller 34 and part of a separate system.

The controller 34 includes at least one processor 44 and a computer-readable storage device or media 46. The processor 44 may be any custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the controller 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10. In various embodiments, controller 34 is configured to implement a path planning system as discussed in detail below.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals that are transmitted to the actuator system 30 to automatically control the components of the autonomous vehicle 10 based on the logic, calculations, methods, and/or algorithms. Although only one controller 34 is shown in FIG. 1, embodiments of the autonomous vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

The communication system 36 is configured to wirelessly communicate information to and from other entities 48, such as but not limited to, other vehicles (“V2V” communication), infrastructure (“V2I” communication), networks (“V2N” communication), pedestrian (“V2P” communication), remote transportation systems, and/or user devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

With reference now to FIG. 2, in various embodiments, the autonomous vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the autonomous vehicle 10 may be associated with an autonomous-vehicle-based remote transportation system. FIG. 2 illustrates an exemplary embodiment of an operating environment shown generally at 50 that includes an autonomous-vehicle-based remote transportation system (or simply “remote transportation system”) 52 that is associated with one or more autonomous vehicles 10a-10n as described with regard to FIG. 1. In various embodiments, the operating environment 50 (all or a part of which may correspond to entities 48 shown in FIG. 1) further includes one or more user devices 54 that communicate with the autonomous vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 may include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a component of a home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, not shown), which may be cloud-based, network-based, or resident at the particular campus or geographical location serviced by the remote transportation system 52. The remote transportation system 52 can be manned by a live advisor, an automated advisor, an artificial intelligence system, or a combination thereof. The remote transportation system 52 can communicate with the user devices 54 and the autonomous vehicles 10a-10n to schedule rides, dispatch autonomous vehicles 10a-10n, and the like. In various embodiments, the remote transportation system 52 stores store account information such as subscriber authentication information, vehicle identifiers, profile records, biometric data, behavioral patterns, and other pertinent subscriber information.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the autonomous vehicles 10a-10n (when and if one is available) to pick up the passenger at the designated pickup location and at the appropriate time. The transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline autonomous vehicle 10 and/or an autonomous vehicle based remote transportation system 52. To this end, an autonomous vehicle and autonomous vehicle based remote transportation system can be modified, enhanced, or otherwise supplemented to provide the additional features described in more detail below.

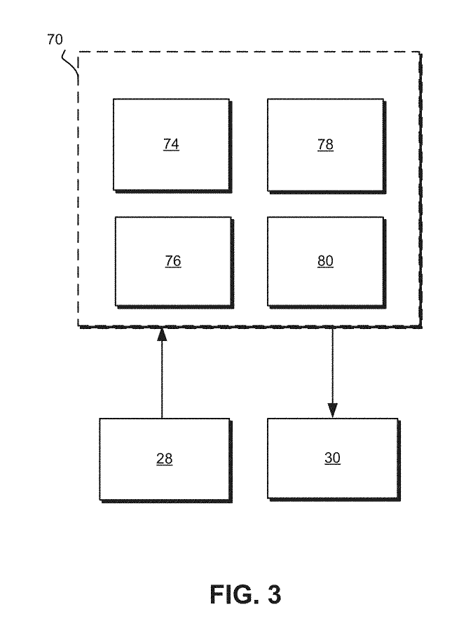

In accordance with various embodiments, controller 34 implements an autonomous driving system (ADS) 70 as shown in FIG. 3. That is, suitable software and/or hardware components of controller 34 (e.g., processor 44 and computer-readable storage device 46) are utilized to provide an autonomous driving system 70 that is used in conjunction with vehicle 10.

In various embodiments, the instructions of the autonomous driving system 70 may be organized by function or system. For example, as shown in FIG. 3, the autonomous driving system 70 can include a computer vision system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the computer vision system 74 synthesizes and processes sensor data and predicts the presence, location, classification, and/or path of objects and features of the environment of the vehicle 10. In various embodiments, the computer vision system 74 can incorporate information from multiple sensors (e.g., sensor system 28), including but not limited to cameras, lidars, radars, and/or any number of other types of sensors.

The positioning system 76 processes sensor data along with other data to determine a position (e.g., a local position relative to a map, an exact position relative to a lane of a road, a vehicle heading, etc.) of the vehicle 10 relative to the environment. As can be appreciated, a variety of techniques may be employed to accomplish this localization, including, for example, simultaneous localization and mapping (SLAM), particle filters, Kalman filters, Bayesian filters, and the like.

The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

It will be understood that various embodiments of the path planning system 100 according to the present disclosure may include any number of sub-modules embedded within the controller 34 which may be combined and/or further partitioned to similarly implement systems and methods described herein. Furthermore, inputs to the path planning system 100 may be received from the sensor system 28, received from other control modules (not shown) associated with the autonomous vehicle 10, received from the communication system 36, and/or determined/modeled by other sub-modules (not shown) within the controller 34 of FIG. 1. Furthermore, the inputs might also be subjected to preprocessing, such as sub-sampling, noise-reduction, normalization, feature-extraction, missing data reduction, and the like.

In various embodiments, all or parts of the path planning system 100 may be included within the computer vision system 74, the positioning system 76, the guidance system 78, and/or the vehicle control system 80. As mentioned briefly above, the path planning system 100 of FIG. 1 is configured to select a path for AV 10 by choosing between the outputs of multiple path planning modules.

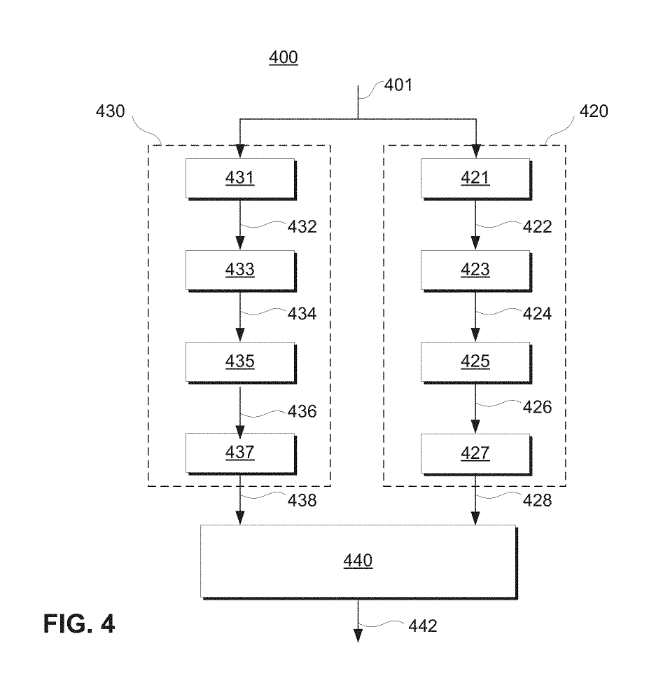

Referring to FIG. 4, an exemplary path planning system 400 generally includes a lattice solver module (or simply “module” 430), a spatiotemporal decision-point solver module (or simply “trumpet solver module” 420, as described below), and a path selection module 440.

In general, trumpet solver module 420 takes as its input sensor data 401 (e.g., optical camera data, lidar data, radar data, etc.) and produces an output 428 specifying a selected (or “proposed”) path that AV 10 may take through a region of interest (e.g., an intersection) while avoiding moving objects (e.g., other vehicles) whose paths might intersect the region of interest during some predetermined time interval, e.g., a “planning horizon.”

Similarly, lattice solver module 430 also takes as its input sensor data 401 and produces an output 438 associated with an elected (or “proposed”) path. The selected path is defined through a region of interest that avoids moving objects (e.g., other vehicles) whose paths might intersect the region of interest during some predetermined time interval, as described below. In some embodiments, the output 428 is expressed, not in the form of a “path” per se, but rather a list of objects and a determination (for each object) as to whether the AV 10 should attempt to move in front of or wait to proceed in back of each object.

Path selection module 440 is configured to determine a selected path (442) given the candidate or proposed paths 438 and 428 provided by lattice solver module 430 and trumpet solver module 420, respectively. As described in further detail below, path selection module 440 may use a variety of decision schemes to produce the selected path 442. In one embodiment, for example, the two competing modules 420 and 430 operate in parallel (with module 420 making proposed paths iteratively) and a decision is made by module 440 based on whether and to what extent module 420 and 430 produces a valid path within a predetermined time-out period.

With continued reference to FIG. 4, in accordance with various embodiments, trumpet solver module 420 includes a region of interest determination module 421, an object path determination module 423, a path space definition module 425, and a graph definition and analysis module 427.

Module 421 is generally configured to define or assist in defining a region of interest and an intended path (422) of the vehicle based on the sensor data 401, as will be illustrated in further detail below. Module 423 is then generally configured to determine a set of predicted paths of one or more objects likely to intersect the region of interest within a planning horizon (e.g., a predetermined length of time), producing a preliminary output 424). Module 425 is generally configured to define, within a spatiotemporal path space associated with the region of interest and the planning horizon, a set of obstacle regions corresponding to the set of predicted paths and a plurality of decision points for each of the obstacle regions (preliminary output 426). Module 427 is generally configured to construct a directed graph based on the plurality of decision points and a cost function applied to a set of path segments interconnecting the decision points, and then search the directed graph to determine a selected path 428 that substantially minimizes the cost function.

Output 428 of trumpet solver module 420 might take a variety of forms, but will generally specify, as a function of time, a path in terms of positions, velocities, and accelerations of the type that might typically be produced by guidance system 78 of FIG. 3. That is, the term “path” as used in connection with the actions of AV 10 will generally include, in addition to positional information as a function of time, a series of planned accelerations, braking events, and the like that will accomplish the intended maneuver. For example, a path may be stored as an ordered set of tuples corresponding to attributes of a maneuver.

In accordance with various embodiments, lattice solver module 430 includes a region of interest determination module 431, an object path determination module 433, an AV state determination module 435, and a graph definition and analysis module 437. In some embodiments, however, a single region of interest determination module (e.g., 421 or 431) is employed to produce a region of interest that is shared by both modules 420 and 430.

In general, module 431 is configured to define or assist in defining a region of interest and an intended path of the vehicle based on the sensor data 401 (generating preliminary output 432). Module 433 is generally configured to determine a set of predicted paths of one or more objects likely to intersect the region of interest within a planning horizon (e.g., a predetermined length of time) (generating preliminary output 434). Module 435 is generally configured to determine a state lattice for AV 10 (e.g., a lattice of states including position and velocity) with respect to the region of interest (generating preliminary output 436). Module 437 is then generally configured to construct a directed graph based on a lattice of future states (e.g., position, velocity) along with a cost function and then determine a candidate (or “proposed”) path 438 that substantially minimizes the cost function. Output 438 of lattice solver module 438 may take a variety of forms, but in one embodiment includes a data structure indicating, for each potential obstacle (as described in detail below), an indication of whether AV 10 should pass in front of or in back of that obstacle.

The modules described above may be implemented as one or more machine learning models that undergo supervised, unsupervised, semi-supervised, or reinforcement learning and perform classification (e.g., binary or multiclass classification), regression, clustering, dimensionality reduction, and/or such tasks. Examples of such models include, without limitation, artificial neural networks (ANN) (such as a recurrent neural networks (RNN) and convolutional neural network (CNN)), decision tree models (such as classification and regression trees (CART)), ensemble learning models (such as boosting, bootstrapped aggregation, gradient boosting machines, and random forests), Bayesian network models (e.g., naive Bayes), principal component analysis (PCA), support vector machines (SVM), clustering models (such as K-nearest-neighbor, K-means, expectation maximization, hierarchical clustering, etc.), linear discriminant analysis models. In some embodiments, training of any models incorporated into module 420 may take place within a system remote from vehicle 10 (e.g., system 52 in FIG. 2) and subsequently downloaded to vehicle 10 for use during normal operation of vehicle 10. In other embodiments, training occurs at least in part within controller 34 of vehicle 10, itself, and the model is subsequently shared with external systems and/or other vehicles in a fleet (such as depicted in FIG. 2).

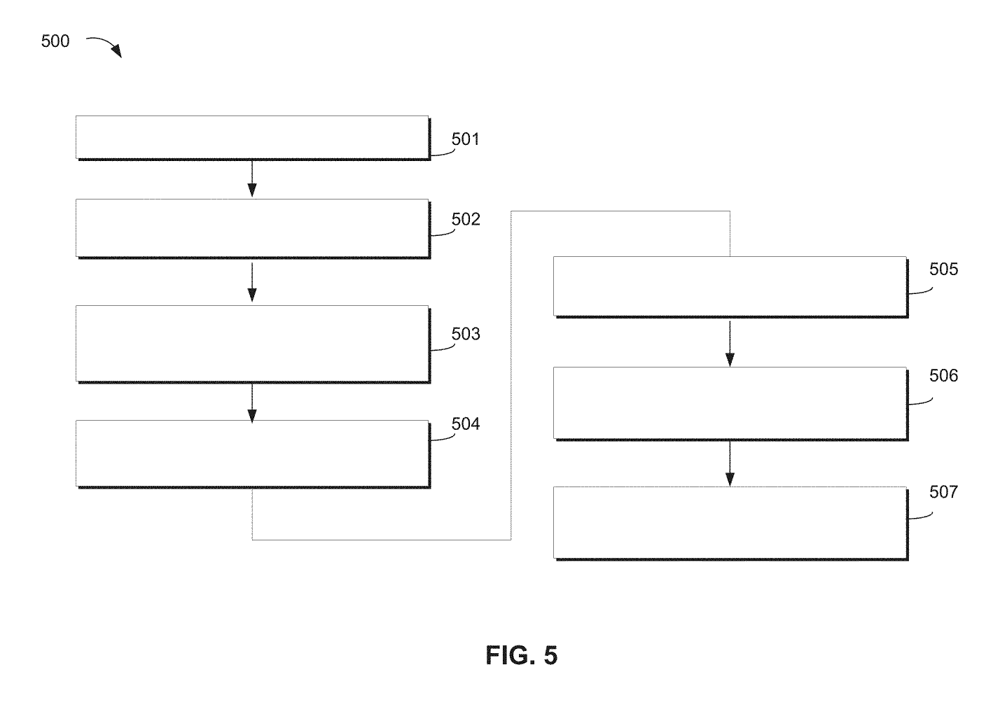

Referring now to FIG. 5, and with continued reference to FIGS. 1-4, the illustrated flowchart provides a control method 500 that can be performed by path planning system 100 (e.g., trumpet solver module 420 of FIG. 4) in accordance with the present disclosure. As can be appreciated in light of the disclosure, the order of operation within the method is not limited to the sequential execution as illustrated in the figure, but may be performed in one or more varying orders as applicable and in accordance with the present disclosure. In various embodiments, the method can be scheduled to run based on one or more predetermined events, and/or can run continuously during operation of autonomous vehicle 10.

In various embodiments, the method begins at 501, in which a “region of interest” and intended path of AV 10 are determined. In general, the phrase “region of interest” refers to any closed spatial region (e.g., roadway, intersection, etc.) through which AV 10 intends to traverse in the near term (e.g., within some predetermined time interval or “planning horizon”). This region may be determined, for example, by guidance system 78 of FIG. 3 in conjunction with module 421, and may be specified in a variety of ways. For example, the region of interest may be defined as a polygon, a curvilinear closed curve, or any other closed shape. In some embodiments, the “width” of the region of interest (i.e., in a direction perpendicular to the intended movement of AV 10 within the region of interest) is equal to the width of AV plus some predetermined margin or buffer distance. It will be understood that the nature of the region of interest and intended path will vary depending upon the context and the maneuver planned for AV 10 (e.g., unprotected left turn, merging with traffic, entering oncoming traffic, maneuvering around a double-parked car, passing a slow car on its left, etc.).

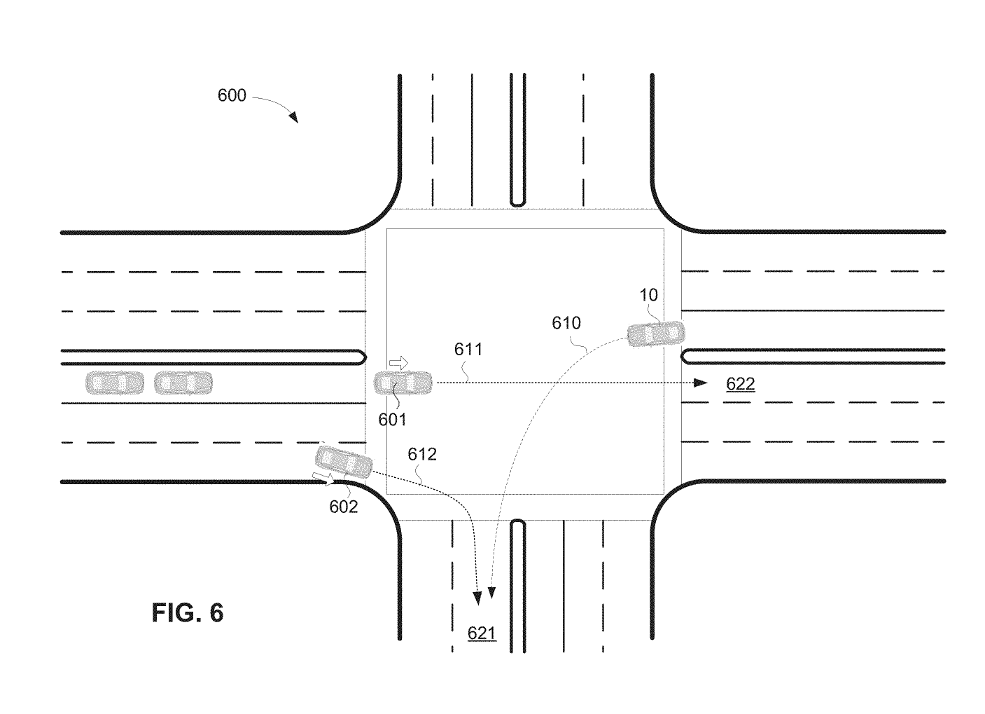

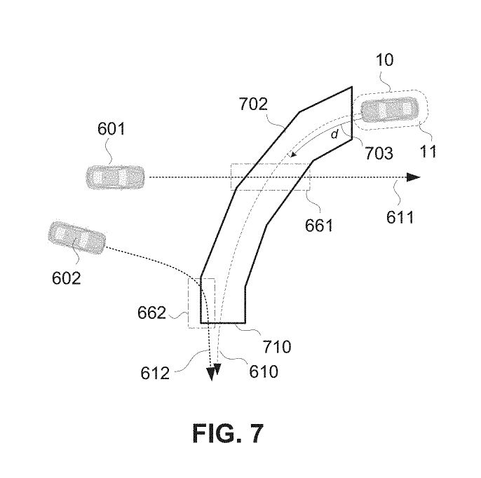

FIG. 6 depicts an example scenario helpful in understanding the present subject matter. As shown, AV 10 has an intended path 610 corresponding to an unprotected left turn into a lane 621 at an intersection 600. Also shown in FIG. 6 are a number of vehicles (or “obstacles”) that might be relevant in deciding whether and/or how AV 10 should complete its turn, as well as its target and acceleration and velocity during that turn. For example, AV 10 may observe an oncoming vehicle 601 whose trajectory indicates that it intends to cross intersection 600 and continue on in lane 622, and another vehicle 602 whose trajectory indicates that it intends to make a right turn into the same lane 621 being targeted by AV 10. The region of interest in this scenario is the area (or lane) that AV 10 will likely traverse in following path 610. In that regard, FIG. 7 depicts a simplified version of FIG. 6 that isolates certain features of the illustrated scenario, namely, a region of interest 702 corresponding to intended path 703 of AV 10 as it takes a left turn, as well as paths 611 and 612 of vehicles 601 and 602, respectively. As mentioned above, while region of interest 702 in FIG. 7 is illustrated as a polygon, the present embodiments are not limited to such representations.

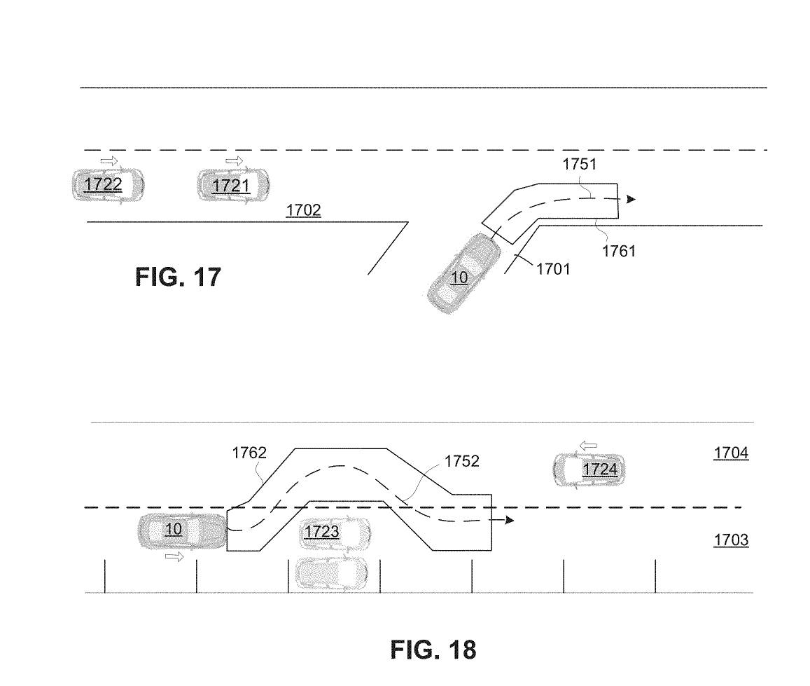

Furthermore, it will be appreciated that the present systems and methods are not limited to unprotected left turn scenarios as depicted in FIG. 6, and may be employed in any context in which AV 10 has an intended path within a region of interest that requires consideration of moving objects (e.g., other vehicles) in the vicinity. Referring momentarily to FIG. 17, for example, systems in accordance with various embodiments may be used in cases in which AV 10 has an intended path 1751 through a region of interest 1761 when attempting to enter lane 1702 from a lane 1701, taking into account oncoming vehicles 1721 and 1722. FIG. 18 shows another example, in which AV 10 has an intended path 1752 that takes it through a region of interest 1762 around a double-parked vehicle 1723, taking into account oncoming vehicle 1724. As shown, path 1752 takes AV 10 from lane 1703, to lane 1704, and back to lane 1703.

Referring again to FIG. 5, the predicted paths of objects (or “obstacles”) likely to intersect the region of interest (and tracked by AV 10 using sensor system 28) are determined (e.g., via module 423) within some predetermined time interval or “planning horizon” (502). This determination may take into account, for example the position, speed, acceleration, pose, size, and any other relevant attribute of nearby objects, as well as the position, size, and geometry of the region of interest and the planning horizon.

Computer vision system 74 of FIG. 3 may be employed to determine which objects, if any, are likely to intersect with the region of interest within the planning horizon. In this regard, the planning horizon time interval may vary depending upon a number of factors, but in one embodiment is between approximately 10-20 seconds, such as 15 seconds. The range of possible embodiments is not so limited, however. Referring again to the example depicted in FIG. 7, it can be seen that paths 611 and 612 intersect (at 661 and 662, respectively) the region of interest 702.

Once the region of interest and possible obstacles are determined, a spatiotemporal path space is then defined by module 425 (at 503) based on the planning horizon and the region of interest. In accordance with one embodiment, the spatiotemporal path space is a planar Cartesian space ( [symbol] ²) in which one axis corresponds to the future travel distance (d) along the intended path of AV, and another axis corresponds to time (t). The travel distance may be expressed in any convenient units (e.g., meters, feet, etc.), and will generally refer to a distance in the forward direction of the vehicle.

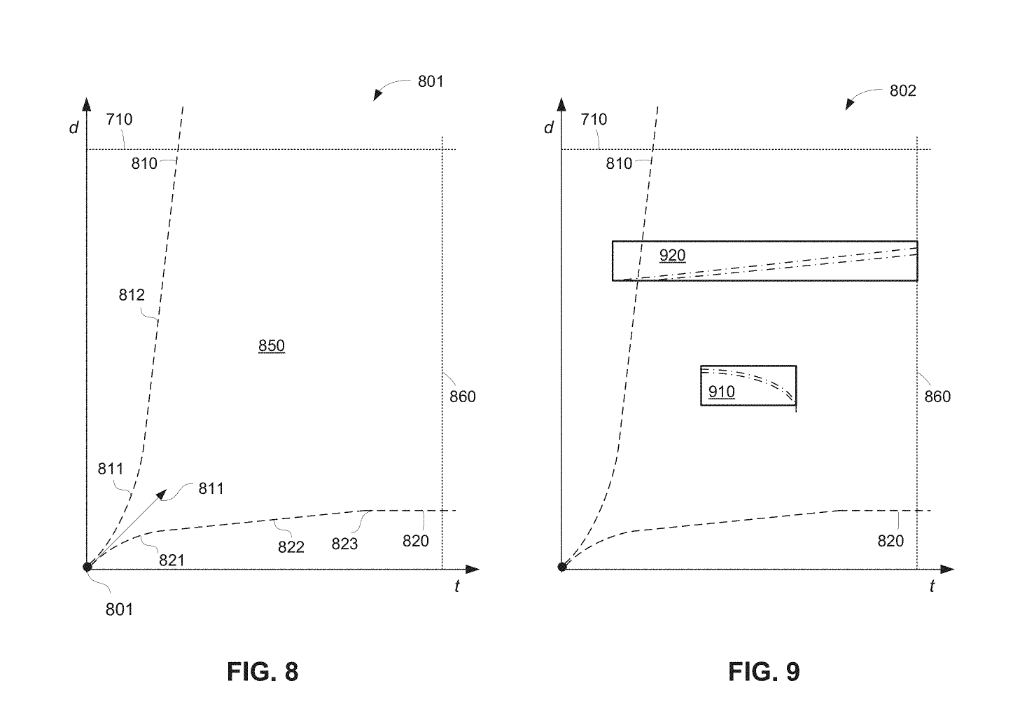

FIG. 8 presents a path planning visualization (or simply “visualization”) 801 illustrating a spatiotemporal path space (or simply “space”) 850 representing a region in which possible path segments (for AV 10 of FIG. 7) may be defined, as described in further detail below. It will be appreciated that visualization 801 (as well as the visualizations that follow) will generally not be literally displayed or graphically represented by system 100. That is, these visualizations are provided in order to provide an intuitive understanding of how system 100 may operate in accordance with various embodiments.

With continued reference to FIG. 8, space 850 of visualization 801 is bounded on the right by the planning horizon 860 (e.g., a predetermined time interval in which AV 10 is attempting to complete a maneuver) and bounded near the top by a line 710 corresponding to the end or terminus of region of interest 702 (e.g., lane end 710 of FIG. 7). The initial condition of AV 10 (corresponding, for example, to the time and position just prior to AV 10 entering the region of interest) corresponds to point 801 (e.g., d, t=[0,0]), and the vector 811 indicates the initial velocity of AV 10 as it enters the region of interest 702.

Thus, the goal of AV 10 will generally be to reach lane end 710 within the planning horizon (topmost horizontal line in FIG. 8). However, it may be the case that AV 10 cannot do so (e.g., due to the presence of many large obstacles intersecting its path), and will instead reach some other intermediary position at the end of the planning horizon 860 (requiring a subsequent path search to complete its intended path).

It will be appreciated that AV 10 may be subject to a set of kinematic constraints, which will generally vary depending upon the nature of AV 10. Such kinematic constraints (which may be embodied as settings configurable by an operator) might include, for example, maximum acceleration, minimum acceleration, maximum speed, minimum speed, and maximum jerk (i.e., rate of change of acceleration).

In this regard, it will be appreciated that the slope of a curve at any point within visualization 801 corresponds to the instantaneous velocity of an object (e.g., AV 10), and the rate of change of slope corresponds to the instantaneous acceleration of that object. Thus, FIG. 8 illustrates two boundaries leading from initial position 801: a boundary 810 corresponding to a maximum acceleration segment 811 followed by a maximum speed segment 812, and a boundary 820 including a minimum acceleration (or maximum deceleration) segment 821, a minimum speed segment 822, and a “stopped” segment 823. It can be seen that boundaries 810 and 820, as they flare outward together from initial position 801, define a shape that is reminiscent of a trumpet bell, hence the shorthand name “trumpet solver” as used herein.

Referring again to FIG. 5, one or more obstacle regions are defined within the spatiotemporal path space (at 504) by module 425. These obstacle regions are configured to specify the estimated future positions of each of the objects identified at 502 relative to AV 10. Thus, obstacle regions may correspond to both stationary and moving obstacles. Referring to FIG. 9, for example, two obstacle regions have been defined in visualization 802: obstacle region 910 (corresponding to path intersection 661 of vehicle 601 in FIG. 7) and obstacle region 920 (corresponding to path intersection 662 of vehicle 602 in FIG. 7).

While regions 910 and 920 are illustrated as rectangles, the range of embodiments is not so limited. The dashed lines within regions 910 and 920 represent the actual paths likely to be taken by vehicles 601 and 602, respectively. Thus, any convenient polygon or curvilinear shape that encompasses these likely paths may be employed. Rectangles, however, are advantageous in that they can easily be modeled and represented, and can be used to generate decision points as described in further detail below. As shown, the rectangles are positioned and oriented such that their sides are parallel to either the distance or time axes, as illustrated.

Once the obstacle regions (e.g., regions 910 and 920) have been defined, system 100 (e.g., module 425) then defines (at 505) decision points (within the spatiotemporal path space) for one or more of the obstacle regions. As used herein, the term “decision point” means a point on the perimeter of (or within some predetermined distance of) an obstacle region as defined previously at 504. In various embodiments—for example, in which the obstacle regions are polygons—the decision points are defined at one or more vertices. In various embodiments, the decision points are defined at (or near) a point on the obstacle region that is a minimum with respect to time (e.g., the leftmost point in a spatiotemporal space as described above), a maximum with respect to time, a minimum with respect to distance (i.e., the topmost point in a spatiotemporal space as described above), and/or a maximum with respect to distance. That is, the left and right boundaries substantially correspond to the end of the points where vehicles 601 and 602 would likely interfere with AV 10.

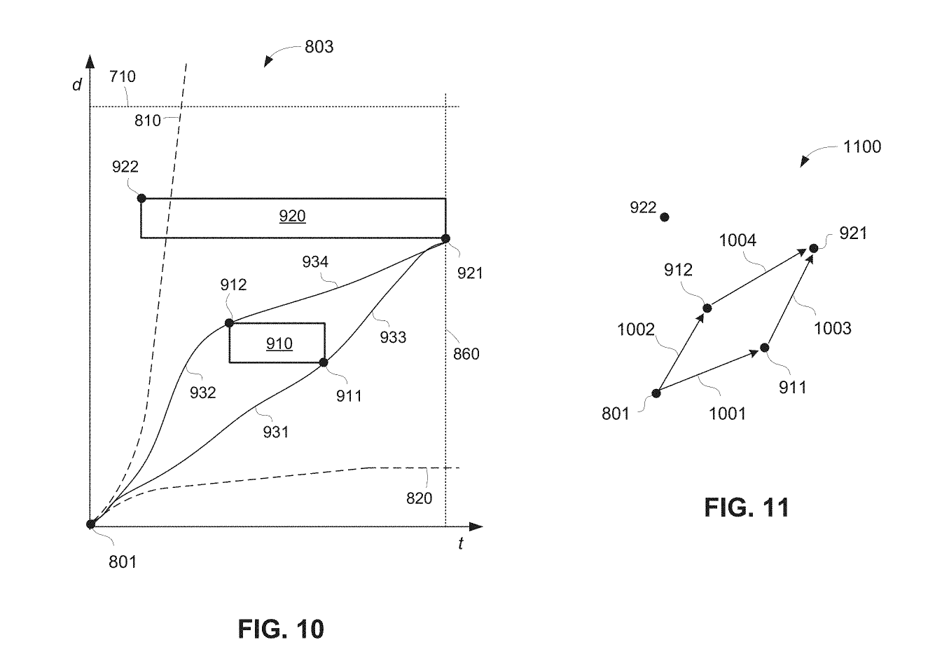

Referring to FIG. 10, for example, two decision points have been defined with respect to each object region. Specifically, decision points 911 and 912 have been defined at opposite corners of object region 910, and decision points 921 and 922 have been defined at opposite corners of object region 920. As shown, decision point 911 is defined at the minimum distance (vertical axis) and maximum time (horizontal axis) of obstacle region 910, while decision point 912 is defined at the maximum distance and minimum time of obstacle region 910.

It will be appreciated that the decision points as shown in visualization 803 of FIG. 10 correspond intuitively to “waypoints” (in terms of position and time) that AV 10 would need to reach to either wait for an object to pass (lower right decision points), or to pass in front of that object (upper left decision points). Thus, decision point 912 corresponds to AV 10 passing in front of vehicle 601, and decision point 911 corresponds to AV 10 waiting for vehicle 601 to pass (e.g., by reducing its speed). It will be appreciated that decision point 922 is unlikely to be reached, since it lies to the left of boundary 810, and would require AV 10 to exceed its kinematic constraints with respect to maximum acceleration and/or maximum speed.

Accordingly, at 506, module 427 defines a graph (e.g., a directed acyclic graph) wherein the vertices of the graph correspond to the decision points (or a subset of the decision points) defined at 505, and the edges of the graph correspond to a particular path segment between the decision points. System 100 further defines a cost value associated with each of the edges, which quantifies the relative desirability of AV following that path segment based on some predetermined cost function.

Referring to FIG. 10, for example, a set of path segments 931-934 are shown. Path segment 932 leads from the initial position 801 to decision point 912, path segment 934 leads from decision point 912 to decision point 921, path segment 931 leads from initial position 801 to decision point 911, and path segment 933 leads from decision point 911 to decision point 921.

FIG. 11 illustrates a directed, acyclic graph corresponding to the visualization 803 of FIG. 10. As shown, graph 1100 includes a set of vertices (or “nodes”) 911, 912, 801, 921, and 922 (corresponding to the equivalent decision points in FIG. 10), and a set of edges 1001, 1002, 1003, and 1004 having the topology shown in FIG. 11. Note that vertex 922 is not connected to the rest of graph 1100. That is, in some embodiments, in the interest of computational complexity, edges are not drawn to or from unreachable vertices.

Referring to the graph of FIG. 11 in conjunction with the visualization of FIG. 10, it will be apparent that AV 10 has two path choices: a first path including path segments 932 and 934, and a second path including path segments 931 and 933. Intuitively, the first path corresponds to AV 10 speeding up slightly to move in front of vehicle 601, then slowing down to let vehicle 602 pass (vertices 801->912->921 in FIG. 11). The second path corresponds to AV 10 staying at approximately the same speed, allowing vehicle 601 to pass, and then speeding up slightly and allowing vehicle 602 to pass (vertices 801->911->921).

In according to various embodiments, a cost function value (or simply “cost”) is assigned to each of the edges of the graph, and a final path is selected to reduce the sum of these costs. For example, referring to FIG. 11, each of the edges 1001-1004 has its own assigned cost, which may be an integer, a real number, or any other quantitative measure that would allow paths to be compared. In various embodiments, cost function produces a number based on various factors. Such factors may include, without limitation: occupant comfort (e.g., lower acceleration and/or jerk), energy usage, distance between AV 10 and obstacles during maneuver (e.g., high cost attached to traveling close to another vehicle), whether and to what extent the end of the region of interest has been reached (i.e., line 710 in FIG. 10), and the like. For example, a cost may be the sum of an occupant comfort value of 10 (on a scale of 1 to 10, 1 being the most desirable), and an energy usage of 5 (on the same scale)—thus, a combined cost of 15. The cost of a particular path is the sum of the costs along the edges (e.g., 1001-1004) defining that path, using any convenient units.

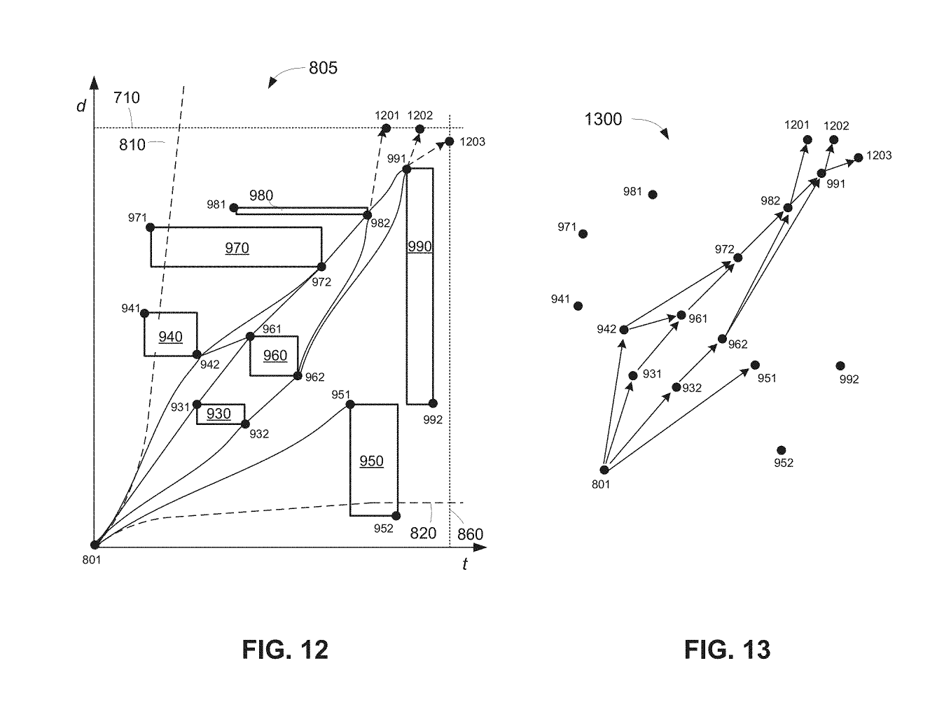

In order to more fully describe the manner in which graphs are constructed based on decision points, FIGS. 12 and 13 present an example visualization 805 and associated graph 1300 in accordance with a more complex scenario in which AV 10 must find a path through seven obstacles of various sizes and speeds. In this example, seven rectangular obstacle regions (930, 940, 950, 960, 970, 980, and 990) have been defined, each corresponding to a different vehicle or other such obstacle. As with the previous example, a pair of decision points have been assigned to each obstacle at that obstacle's upper left and lower right corners. Thus, decision points 931 and 932 are assigned to obstacle region 930, decision points 941 and 942 are assigned to obstacle region 930, decision points 951 and 952 are assigned to obstacle region 950, decision points 961 and 962 are assigned to obstacle region 960, decision points 971 and 972 are assigned to obstacle region 970, decision points 981 and 982 are assigned to obstacle region 980, and decision points 991 and 992 are assigned to obstacle region 990.

In the interest of clarity, the individual path segments have not been separately numbered in FIG. 12, but can be designated by specifying an order set of consecutive decision points, e.g., path {801, 932, 962, 982, 991, 1203}. Note that decision points 941, 971, and 981 are not connected to the rest of graph 1300, as those points are not reachable given the kinematic constraints, as described above.

In order to construct graph 1300, an edge is drawn between a first vertex and a second vertex if an only if (a) the second vertex is subsequent in time to the first vertex, (b) the second vertex has a greater distance d than the first vertex, (c) the resulting edge would not pass through an obstacle region, and (d) the resulting edge would not exceed a kinematic constraint (such as maximum speed). Thus, for example, decision point 962 is connected to both decision points 982 and 991, but is not connected to decision point 972 (which would require reaching an unreachable speed) or decision point 1203 (which would require passing through obstacle region 990).

Note that three “endpoints” are illustrated in FIG. 12—decision points 1201, 1202, and 1203. Decision points 1201 and 1202 correspond to reaching the end of the lane 710 (i.e., finishing the maneuver through the region of interest), and decision point 1203 corresponds to the case of reaching the end of the planning horizon 860 before reaching the end of the lane 710. These end points may be selected from all candidate end points lying on lines 710 and 860 in a variety of ways. In one embodiment, for decision points closest to lines 710 and 860, the ending speed of every path segment leading to that decision point is considered and projected until it intersects either line 710 or 860. These intersections are then added as vertices to graph 1300. Thus, for example, it can be seen that an AV 10 proceeding along path segment {962, 982} would, if it maintained the same speed, reach vertex 1201. Similarly, path segment {962, 991} would result in vertex 1202, and path segment {982, 991} would result in vertex 1203.

Referring again to FIG. 5, having thus constructed a graph and assigned costs to its edges, a suitable graph search is performed (at 507) to select a best-case (lowest total cost) path. That is, a sequence of path segments are selected that accomplishes the desired goal of AV 10 (e.g., traveling along its intended path and completing its traversal of the region of interest, or reaching the end of the planning horizon) while minimizing the sum of the costs of the selected path segments. A variety of methods may be used to perform this search. In one embodiment, a Djikstra graph search algorithm is used. In another embodiment, an A* graph search algorithm is used. Regardless of the particular method used to select an optimal or near-optimal path, the result is a selected path corresponding to the output 428 of trumpet solver module 420 in FIG. 4.

For example, referring again to the scenario illustrated in FIGS. 12 and 13, system 100 might determine that the lowest-cost path is described by the ordered set of vertices {801, 923, 991, 1202}. Intuitively, it can be seen that this is a reasonable choice, since the resulting path requires very few changes in velocity and has an endpoint 1202 at the end of the region of interest (i.e., the intended maneuver has been completed). The output 428 of module 420 would then include a set of kinematic values, stored in any convenient data structure, that specifies the sequence of acceleration, velocity, and position values required by AV 10 to accomplish the selected path.

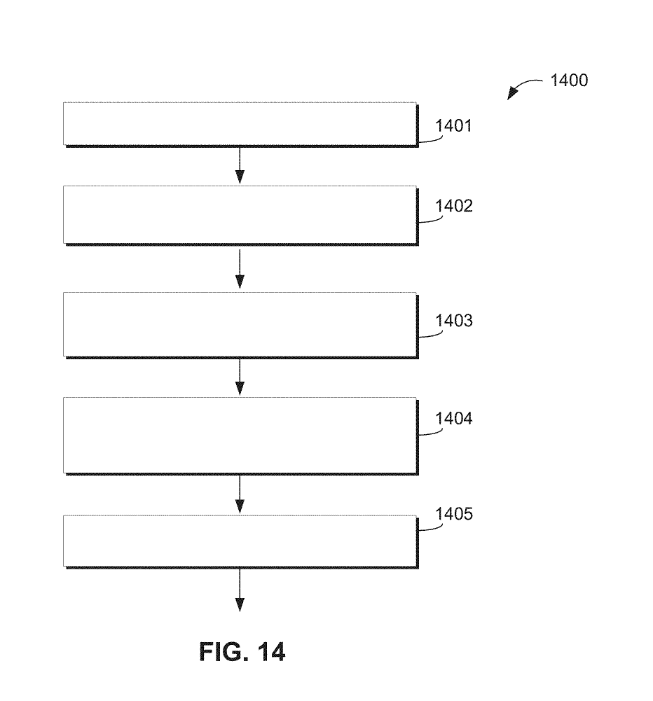

Referring now to FIG. 14, and with continued reference to FIGS. 1-13, the illustrated flowchart provides a control method 1400 that can be performed by path planning system 100 (e.g., module 430 of FIG. 4) in accordance with the present disclosure. As can be appreciated in light of the disclosure, the order of operation within the method is not limited to the sequential execution as illustrated in the figure, but may be performed in one or more varying orders as applicable and in accordance with the present disclosure. In various embodiments, the method can be scheduled to run based on one or more predetermined events, and/or can run continuously during operation of autonomous vehicle 10.

In various embodiments, the method begins at 1401, in which a “region of interest” and intended path of AV 10 are determined, as described above. This region may be determined, for example, by guidance system 78 of FIG. 3 in conjunction with module 431 of FIG. 4, and may be specified in a variety of different manners. For example, the region of interest may be defined as a polygon, a curvilinear closed curve, or any other closed shape. In one embodiment, the region of interest pertains to the execution of a left turn or a right turn through an intersection; however, the range of applications is not so limited. It will be understood that the nature of the region of interest and intended path will vary depending upon the context and the maneuver planned for AV 10 (e.g., unprotected left turn, merging with traffic, entering oncoming traffic, maneuvering around a double-parked car, passing a slow car on its left, and so on).

Referring again to FIG. 14, in various embodiments a current state of AV 10 and/or the region of interest is determined at 1401. In various embodiments, the current state of the AV 10 includes a time value (e.g., a future point in time relative to a current point in time) along with an expected relative position and velocity of the AV 10 with respect to the region of interest, along with predicted locations of other vehicles and other objects in proximity thereto. Also in various embodiments, the current state of the AV 10 is determined via the AV state determination module 450 of FIG. 4, for example based on sensor data from the sensor system 28 of FIG. 1.

Also in various embodiments, at 1402 the predicted paths of objects (or “obstacles”) likely to intersect the region of interest (and tracked by AV 10 using sensor system 28) are determined (e.g., via the object path determination module 433 of FIG. 4) within some predetermined time interval or “planning horizon”. In various embodiments, these determinations may take into account, for example the position, speed, acceleration, pose, size, and any other relevant attribute of nearby objects, as well as the position, size, and geometry of the region of interest and the planning horizon.

In various embodiments, computer vision system 74 of FIG. 3 may be employed to determine which objects, if any, are likely to intersect with the region of interest within the planning horizon. In this regard, the planning horizon time interval may vary depending upon a number of factors, but in one embodiment is between approximately 10-20 seconds, such as 15 seconds. The range of possible embodiments is not so limited, however. Referring again to the example depicted in FIG. 7, it can be seen that paths 611 and 612 intersect (at 661 and 662, respectively) the region of interest 702.

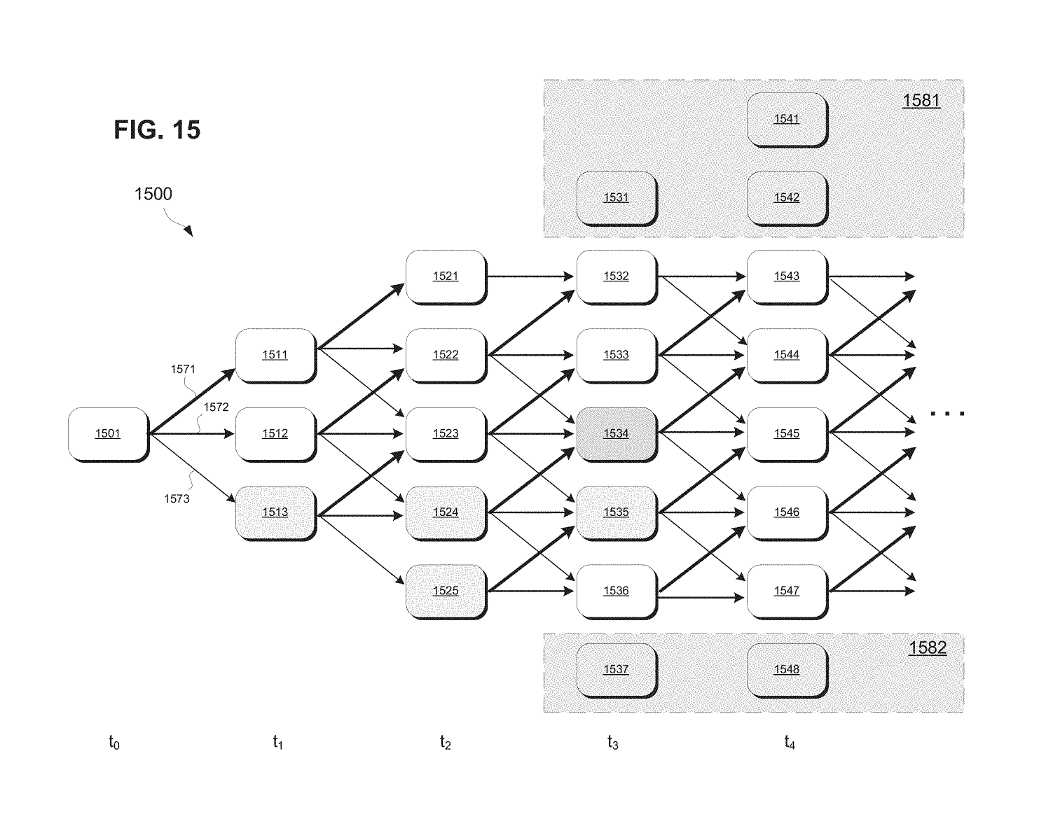

A lattice of future states is defined at 1403. In various embodiments, the lattice definition module 435 of FIG. 4 (e.g., using one or more processors, such as the processor 44 of FIG. 4) defines a lattice of future states for the AV 10 and/or the region of interest at various future points in time relative to a current time. In various embodiments, the lattice comprises nodes of the lattice solver graph 1500 depicted in FIG. 15 and described further below in connection therewith. For example, in various embodiments, each node of the lattice represents a time value along with parameter values for a corresponding state of the AV 10 and/or region of interest at such point in time of the future that is associated with the time value. In various embodiments, similar to the discussion above, the parameter values include, for each particular point in time, an expected relative position and velocity of AV 10 with respect to the region of interest, along with predicted locations of other vehicles and other objects in proximity thereto.

In addition, in various embodiments, a directed graph is generated at 1404 that corresponds to the lattice defined at 1403. In various embodiments, the directed graph connects various nodes of the lattice based on an discretized acceleration or deceleration of the AV 10. Also in various embodiments, the lattice solver graph comprises a plurality of connected nodes, with the first node representing a current time and a current state, and each subsequent node being dependent upon on one or more prior nodes. Also in various embodiments, the directed graph includes various associated costs for the various nodes based on a cost function that is applied for the respective states of the AV 10 relative to the region of interest for each of the various nodes. In various embodiments, the graph definition and analysis module 437 of FIG. 4 (e.g., using one or more processors, such as the processor 44 of FIG. 4) generates the directed graph for the AV 10.

With reference to FIG. 15, an exemplary lattice solver graph 1500 is depicted, in accordance with exemplary embodiments. In various embodiments, the lattice solver graph 1500 utilizes a heuristic approach to path planning and constraint processing. In addition, in various embodiments, the lattice solver graph 1500 is generated dynamically “on-the-fly” as AV 10 is operated. In certain embodiments, the lattice solver graph 1500 could be pre-generated within the constraints of the planning problem (e.g., with a possible discretized travel and time limits that define the “planning horizon”). However, in various embodiments, such a pre-computation may not be necessary for solving the problem correctly and quickly via the lattice solver graph 1500.

As shown in FIG. 10, the lattice solver graph 1500 includes a first node 1501 representing an initial state of the AV 10, along with various subsequent nodes 1511-1548 for various future states of the AV 10 at various different future points in time under various different scenarios, in accordance with various embodiments.

Also in various embodiments, each of the subsequent nodes 1511-1548 has a cost associated therewith, as determined via application of a cost function with respective states associated with the various nodes and with respect to transitions between the nodes. For example, in various embodiments, an assigned cost associated with each node (and/or transition between nodes) may be an integer, a real number, or any other quantitative measure that would allow different nodes and corresponding paths to be compared. In various embodiments, the cost function produces a cost number for each specific node (and/or transition between nodes) that is based on the cost function as applied to various factors of the particular node that pertain to the state of the AV 10 with respect to the region of interest. Also in various embodiments, the cost function is also applied to transitions between the various nodes. For example, in various embodiments, such factors may include, without limitation: whether another vehicle or other object is likely to contact the AV 10 (with a relatively high cost in the event of contact), whether or not another vehicle or other object is likely to intersect with a path of the AV 10 such as to require an evasive maneuver (with a relatively high cost associated with such a maneuver, but potentially less than the cost of contact itself), whether or not another vehicle or other object is likely to come sufficiently close to contacting the AV 10 such as to potentially make a passenger of the AV 10 uncomfortable (also with a relatively high cost associated with such a maneuver, but potentially less than the cost of contact itself), the type of object that the AV 10 contact or nearly contact (e.g., with a relatively higher cost for near contact with a pedestrian or bicyclist as compared with other vehicles or other objects), one or more other measures of occupant comfort (e.g., relatively higher costs associated with higher levels of acceleration, velocity, and/or jerk), energy usage (e.g., relatively higher costs with higher energy usage, all else being equal), whether and to what extent the end of the region of interest has been reached (e.g., with relatively higher costs for a longer duration to reach the end of the region of interest, all else being equal), and the like.

In various embodiments, the first node 1501 includes an initial state that comprises an initial position and velocity of the AV 10 with respect to the region of interest. In various embodiments, the first node 1501 is associated with a beginning or origin time for the method 500, referred to as Time Zero (or t0). From the first node 1501, the lattice solver graph 1500 initially proceeds in one of three directions 1571, 1572, or 1573 based on potential discretized accelerations of AV 10.

If the AV 10 is decelerating (i.e., if the acceleration of AV 10 is less than zero at time zero), then the lattice solver graph 1500 proceeds in a first direction 1571, to reach node 1511. Specifically, in various embodiments, node 1511 refers to a state of the AV 10 at a first subsequent point in time during the method 500, referred to as Time One. In various embodiments, Time One (t₁) corresponds to a point in time that is immediately subsequent to Time Zero, i.e., after a time step. In certain embodiments, the time step may be equal to approximately 0.5 seconds; however, this may vary in other embodiments.

Accordingly, in various embodiments, node 1511 includes the state of the AV 10. In various embodiments, the state of the AV 10 represented at node 1511 includes a relative position, velocity, and acceleration of the AV 10 with respect to the region of interest, and including information as to any other detected vehicles or other objects, including a proximity of the AV 10 with respect to the other vehicles or other objects, and related parameters (e.g., whether another vehicle or other object is likely to contact the AV 10, whether or not another vehicle or other object is likely to intersect with a path of the AV 10 such as to require an evasive maneuver, whether or not another vehicle or other object is likely to come sufficiently close to contacting the AV 10, energy usage, proximity to the end of the region of interest, and the like). In addition, in various embodiments, node 1511 includes a cost, based on an application of the cost function to the AV 10 state represented at node 1511. In certain embodiments, the cost associated with node 1511 may be relatively low, for example with relatively smooth deceleration, and provided that there is sufficient distance between the AV 10 and any other vehicles or other objects.

With reference again to the first node 1501, if the AV 10 is neither accelerating nor decelerating (or, in certain embodiments, if the acceleration or deceleration is minimal, or less than a predetermined threshold), then the lattice solver graph 1500 proceeds in a second direction 1572 to reach node 1512. Specifically, in various embodiments, node 1512 refers to another state of the AV 10 at the above-referenced Time One (t1).

Accordingly, in various embodiments, node 1512 includes the state of the AV 10 at Time One (t1) in a different scenario, in which there is no (or minimal) acceleration or deceleration. In various embodiments, the state of the AV represented at node 1512 includes a relative position, velocity, and acceleration of the AV 10 with respect to the region of interest, along with the other related parameters discussed above with respect to node 1511. Also similar to the discussion above, in various embodiments, node 1512 similarly includes a cost, based on an application of the cost function to the AV 10 state represented at node 1512. In certain embodiments, the cost associated with node 1512 may also be relatively low, for example with little or no acceleration, and provided that there is sufficient distance between the AV 10 and any other vehicles or other objects.

With reference once again to the first node 1501, if the AV 10 is accelerating (or, in certain embodiments, if the acceleration is greater than a predetermined threshold, such as to potentially cause discomfort for a passenger of the AV 10), then the lattice solver graph 1500 proceeds in a third direction 1573 to reach node 1513. Specifically, in various embodiments, node 1513 refers to another state of the AV 10 at the above-referenced Time One (t1).

Accordingly, in various embodiments, node 1513 includes the state of the AV 10 at Time One (t1) in a different scenario, in which there is acceleration (e.g., that is greater than a predetermined threshold). In various embodiments, the state of the AV 10 represented at node 1513 includes a relative position, velocity, and acceleration of the AV 10 with respect to the region of interest, along with the other related parameters discussed above with respect to node 1511. Also similar to the discussion above, in various embodiments, node 1513 similarly includes a cost, based on an application of the cost function to the AV 10 state represented at node 1513. In certain embodiments, the cost associated with node 1513 may be moderate in magnitude (e.g., greater than the costs of 1511 and 1512, due to potential passenger discomfort that may be associated with a relatively large acceleration for the AV 10, but less than other states, for example in which another vehicle or other object may contact the AV 10, and so on).

Also in various embodiments, for each respective node 1511, 1512, and 1513, the lattice solver graph 1500 reaches the next respective node using one of the three directions 1571, 1572, or 1573 based on the acceleration of the AV 10 at the point in time associated with the respective node 1511, 1512, or 1513. Specifically, one of nodes 1521-1525 are reached at Time Two (t2), for example corresponding to a passage of time equal to the time step from Time One. For example, as discussed above, in certain embodiments the time step may be approximately equal to 0.5 seconds; however, this may vary in other embodiments.

Specifically, in various embodiments, from node 1511, the lattice solver graph 1500 proceeds, for Time Two (t2), to: (i) node 1521, if the AV 10 is decelerating; (ii) node 1522, if the AV 10 is neither accelerating or decelerating (or, e.g., is accelerating less than a predetermined threshold); or (iii) node 1523, if the AV 10 is accelerating (e.g., greater than a predetermined).

Similarly, in various embodiments, from node 1512, the lattice solver graph proceeds, for Time Two (t2), to: (i) node 1522, if the AV 10 is decelerating; (ii) node 1523, if the AV 10 is neither accelerating or decelerating (or, e.g., is accelerating less than a predetermined threshold); or (iii) node 1524, if the AV 10 is accelerating (e.g., greater than a predetermined).

Likewise, in various embodiments, from node 1513, the lattice solver graph proceeds, for Time Two (t2), to: (i) node 1523, if the AV 10 is decelerating; (ii) node 1524, if the AV 10 is neither accelerating or decelerating (or, e.g., is accelerating less than a predetermined threshold); or (iii) node 1525, if the AV 10 is accelerating (e.g., greater than a predetermined).

For each of the nodes 1521-1525 of Time Two (t2), each node includes a different respective state of the AV 10, including a relative position, velocity, and acceleration of the AV 10 with respect to the region of interest, along with the other related parameters discussed above for each node. Also in various embodiments, each of the nodes 1521-1525 similarly include a respective cost, based on an application of the cost function to the AV 10 state represented at the respective node. In certain embodiments, and in certain circumstances: (i) the cost associated with node 1521 may be relatively low (e.g., without acceleration, and with a reasonable distance from objects); (ii) the cost associated with nodes 1522 and 1523 may be significantly high (e.g. representing possible contact with another vehicle or object); and (iii) the costs associated with nodes 1524 and 1525 may be moderate (e.g., with some possible discomfort due to significant acceleration, but less costly than contact with another vehicle, by way of example). Of course, the respective costs of the various nodes may vary in different embodiments, and also in various different scenarios that may be encountered within each of the different embodiments, and so on.

Similarly, for Time Three (t3), the lattice solver graph 1500 proceeds toward one of nodes 1531-1537, depending upon the node occupied at Tine Two (t2) and the acceleration or deceleration of the AV 10 at that time.

As illustrated with respect to the nodes 1531-1537 of Time Three (t3), in various embodiments, at any particular point in time, the lattice solver graph 1500 will effectively delete or ignore any nodes for which a corresponding velocity of the AV 10 is less than a first predetermined threshold or greater than a second predetermined threshold. For example, in various embodiments, the lattice solver graph 1500 will effectively delete or ignore any nodes for which a corresponding velocity of the AV 10 is less than zero or greater than a maximum speed limit for the AV 10. In certain embodiments, the maximum speed limit for the AV 10 corresponds to a maximum speed for the AV 10 under any circumstances, regardless of the roadway, for safe and reliable operation of the AV 10. In certain other embodiments, the maximum speed for the AV 10 pertains to a maximum speed limit for a roadway on which the AV 10 is travelling.

For example, with continued reference to the nodes 1531-1537 of Time Three (t3), node 1531 is effectively ignored or deleted from the lattice solver graph 1500 as being part of a first group 1581 of nodes in which the velocity of the AV 10 is less than zero. Also by way of example, node 1537 is effectively ignored or deleted from the lattice solver graph 1500 as being part of a second group 1582 of nodes in which the velocity of the AV 10 is greater than a maximum speed for the AV 10. For example, by effectively ignoring or deleting such nodes, the computational speed and/or efficiency of the latter solver graph 1500 may be increased.

For each of the nodes 1532-1536 of Time Three (t3) that remain under consideration in the lattice solver graph 1500, each node includes a different respective state of the AV 10, including a relative position, velocity, and acceleration of the AV 10 with respect to the region of interest, along with the other related parameters discussed above for each node. Also in various embodiments, each of the nodes 1532-1536 similarly include a respective cost, based on an application of the cost function to the AV 10 state represented at the respective node. In certain embodiments, and in certain circumstances: (i) the costs associated with nodes 1533 and 1534 may be relatively low (e.g., without significant acceleration, and with a reasonable distance from objects); (ii) the costs associated with nodes 1535 and 1536 may be moderate (e.g., with some possible discomfort due to significant acceleration, but less costly than contact with another vehicle, by way of example); and (iii) the cost associated with node 1532 may be moderate to high, for example due to an evasive action that may be required to avoid contact with another vehicle or object. Of course, the respective costs of the various nodes may vary in different embodiments, and also in various different scenarios that may be encountered within each of the different embodiments, and so on.

Similarly, for Time Four (t4), the lattice solver graph 1500 proceeds toward one of nodes 1541-1548, depending upon the node occupied at Time Three (t3) and the acceleration or deceleration of the AV 10 at that time.

Similar to the discussion above, in various embodiments nodes 1541 and 1542 are effectively ignored or deleted from the lattice solver graph 1500 as being part of the first group 1581 of nodes in which the velocity of the AV 10 is less than zero. Also in various embodiments, node 1548 is effectively ignored or deleted from the lattice solver graph 1500 as being part of the second group 1582 of nodes in which the velocity of the AV 10 is greater than a maximum speed for the AV 10.

For each of the nodes 1543-1547 of Time Four (t4) that remain under consideration in the lattice solver graph 1500, each node includes a different respective state of the AV 10, including a relative position, velocity, and acceleration of the AV 10 with respect to the region of interest, along with the other related parameters discussed above for each node. Also in various embodiments, each of the nodes 1543-1547 similarly include a respective cost, based on an application of the cost function to the AV 10 state represented at the respective node. In certain embodiments, and in certain circumstances: (i) the costs associated with nodes 1545 may be relatively low (e.g., without significant acceleration, and with a reasonable distance from objects); (ii) the costs associated with nodes 1546 and 1547 may be moderate (e.g., with some possible discomfort due to significant acceleration, but less costly than contact with another vehicle, by way of example); and (iii) the costs associated with node 1543 and 1544 may be moderate to high, for example due to another vehicle or other object coming sufficiently close to the AV 10 so as to potentially cause discomfort for a passenger of the AV 10. Of course, the respective costs of the various nodes may vary in different embodiments, and also in various different scenarios that may be encountered within each of the different embodiments, and so on.

In various embodiments, additional nodes may similarly be constructed for the lattice solver graph 1500 at any number of future points of time. Also in various embodiments, such nodes may similarly reflect respective states of the AV 10 with respect to the region of interest, with associated respective costs using the cost function. In certain embodiments, such additional nodes are generated for additional points in time until either a maximum time threshold is utilized and/or until the respective states would extend beyond the region of interest.

Referring again to FIG. 5, having thus constructed a directed graph and assigned costs for the various nodes of the lattice solver graph 1500, a suitable graph search is performed (at 510) to select a best-case (lowest total cost) path for AV 10 to travel. For example, in certain embodiments, a sequence of path segments are selected using the various nodes of the lattice solver graph 1500 that accomplishes the desired goal of AV 10 (e.g., traveling along its intended path and completing its traversal of the region of interest, or reaching the end of the planning horizon) while minimizing the sum of the costs of the selected path segments. In various embodiments, a variety of methods may be used to perform this search. In one embodiment, a Djikstra graph search algorithm is used. In another embodiment, an A* graph search algorithm is used. Regardless of the particular method used to select an optimal or near-optimal path, in various embodiments, the result is a selected path corresponding to the output 461 of lattice solver module 430 in FIG. 4.

For example, referring again to the exemplary lattice solver graph 1500 of FIG. 10, in certain embodiments the system 100 might determine that the lowest-cost path is described by the ordered set of nodes {1501, 1511, 1521, 1533, 1545}. Intuitively, it can be seen that this is a reasonable choice, for example because the resulting path would help to (i) avoid unwanted contact with other vehicles or objects (e.g., avoiding such high cost nodes as a first priority, based on an associated high weighting within the cost function), while also (ii) avoiding, to the extent possible, evasive maneuvers and close contact with other vehicles or objects (e.g., avoiding such moderate to high cost nodes as a second priority, based on an associated medium weighting within the cost function); and while also (iii) avoiding or reducing, to the extent possible, other potentially uncomfortable states such as increased acceleration (e.g., avoiding such moderate cost nodes, or other moderate cost modes, such as a longer travel time, higher energy usage, or the like, as a third priority, based on an associated moderate weighting within the cost function), in certain embodiments.

With reference back to FIG. 5, in various embodiments, the selected path is implemented by the AV 10 at 514. In various embodiments, the selected path is implemented by the vehicle control system 80 of FIG. 3, for example, via instructions provided via the processor 44 of FIG. 1 that are implanted by the propulsion system 20, steering system 24, and brake system 26 of FIG. 1, in various embodiments. Also in various embodiments, the method 500 may terminate when the AV 10 exits the region of interest.

In various embodiments the path that is selected or proposed may include a seeding and/or a rough and/or preliminary possible path for travel of the AV 10 based at least in part on potential objects nearby the AV 10 and/or the path, for further refinement by a path planning system of the AV 10 prior to implementation for movement of the AV 10. Accordingly, in various embodiments, the selected path is used to identify which obstacles should be considered “front” or “rear” obstacles (that is, which obstacles the AV 10 should travel in front of or behind), for example by filtering predicted obstacles and making yielding decisions for refinement and implementation as part of a larger computer control system. Also in various embodiments, an initial or seeded path determined via the method 500 may be implemented at 514 by utilizing the initial or seeded path as a starting point, then further refining the path via a path planning system of the AV 10 (such as that discussed above), and ultimately causing the AV 10 to travel along the refined path.

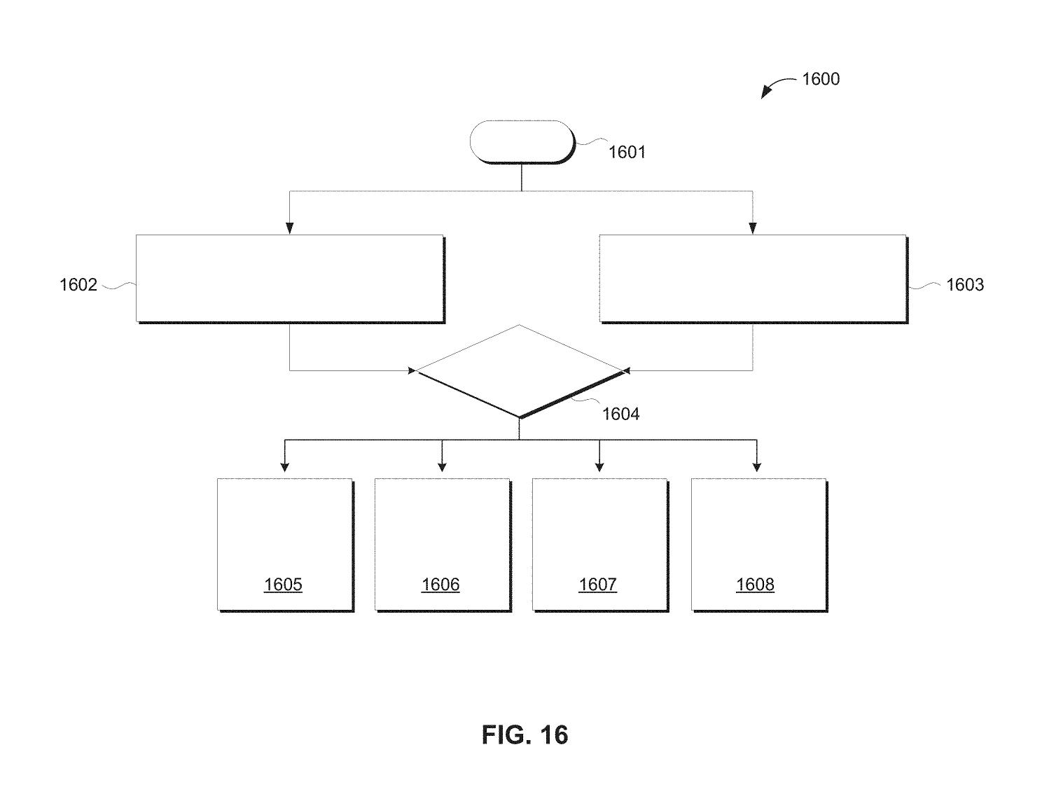

Referring now to FIG. 16, and with continued reference to FIGS. 1-15, the illustrated flowchart provides a control method 1600 that can be performed by path planning system 100 in accordance with the present disclosure. As can be appreciated in light of the disclosure, the order of operation within the method is not limited to the sequential execution as illustrated in the figure, but may be performed in one or more varying orders as applicable and in accordance with the present disclosure. In various embodiments, the method can be scheduled to run based on one or more predetermined events, and/or can run continuously during operation of autonomous vehicle 10.

First, at 1601, it is assumed that a region of interest and intended path has been defined (e.g., via module 421 and/or module 431 of FIG. 4 as described above). Subsequently, in parallel, two operations or processes take place. Namely, at 1602, the trumpet solver module 420 begins to determine a first proposed path. In some embodiments, this process is performed iteratively using some suitable criteria for terminating the process and selecting a path. In one embodiment, for example, this process includes increasing or decreasing values of a “spatial comfort level” (e.g., a distance or “comfort margin” from AV 10 to surrounding objects as it travels through proposed paths, as discussed above).

At substantially the same time that trumpet solver 420 begins to determine the first proposed path, lattice solver module 430 begins to determine a second proposed path and an associated spatial comfort level as described above in connection with FIGS. 14 and 15.

Next, at 1604, the system determines whether one or more valid paths have been determined before some time-out period (e.g., within a range of about 1.0 to 10.0 ms, such as 5.0 ms) has been exceeded. The selection of a proposed path is then performed in accordance with whether and to what extent each of the modules 420, 430 has determined a valid path within the predetermined time period. In one embodiment, for example, a counter or other such timer is initiated at 1601, and after a predetermined time interval, the system determines (at 1604) whether a valid output has been produced at 1602 or 1603. In this regard, the term “valid path” refers to a path that fulfills whatever criteria has been defined in connection with such processes.

The method proceeds based on the determination made at 1604. Thus, as illustrated, if only trumpet solver module 420 has determined a valid path before time-out, then the first proposed path (from trumpet solver module 420) is selected (at 1605). Similarly, if only lattice solver module 430 has determined a valid path before time-out, then the first proposed path (from trumpet solver module 420) is selected (at 1606).

In accordance with various embodiments, if both trumpet solver module 420 and lattice solver module 430 have determined a valid path before time-out, then the path with the greatest spatial comfort level is selected (at 1607). That is, a path is selected based on how far away AV 10 is from surrounding objects as it travels along the proposed path. The spatial comfort level might be expressed and stored as a minimum distance from other vehicles in the vicinity.

In accordance with various embodiments, if neither trumpet solver module 420 nor lattice solver module 430 has determined a valid path before time-out, then a path is selected from a previous solve attempt (at 1608). In this respect, a variety of simple fallback modes may be implemented. Since the primary output of the illustrated system is a decision whether to travel ahead of or behind any given vehicle, it is often possible to re-use the assignments that were determined at an earlier time. In cases where this is not possible (e.g., when new vehicles have appeared since the most recent successful solve), assignments can still be made according to a recent motion plan, which may be generated by a different system, and may include simply determining whether that plan would result in a path that takes AV 10 ahead of or behind the nearby vehicles.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of path planning comprising:
receiving sensor data relating to an environment associated with a vehicle;
defining, with a processor, a region of interest and an intended path of the vehicle based on the sensor data;
determining a set of predicted object paths of one or more objects likely to intersect the region of interest;
determining, with a processor, a first candidate path that minimizes a first cost function applied to a spatiotemporal decision-point graph constructed based on the predicted object paths;
determining, with a processor, a second candidate path that minimizes a second cost function applied to a state lattice graph constructed based on the predicted object paths; and
determining a selected path from the first and second candidate paths based on a set of selection criteria.

2. The method of claim 1, wherein determining the first candidate path includes:
defining, within a spatiotemporal path space associated with the region of interest and a planning horizon, a set of obstacle regions corresponding to the set of predicted paths;
defining a plurality of decision points for each of the obstacle regions;
defining the spatiotemporal decision-point graph based on the plurality of decision points and the first cost function applied to a set of path segments interconnecting the decision points; and
performing, with a processor, a search of the spatiotemporal decision-point graph to determine a selected path.

3. The method of claim 2, wherein defining the spatiotemporal decision-point graph includes providing a directed edge between a first decision point to a second decision point if: the second decision point is subsequent in time to a first vertex; the second decision point corresponds to a greater distance than the first decision point; the directed edge would not pass through one of the obstacle regions; and the directed edge would not exceed a kinematic constraint associated with the vehicle.

4. The method of claim 1, wherein determining the second candidate path includes:
defining a lattice solver graph comprising a plurality of nodes, each of the plurality of nodes comprising a state of the vehicle and an associated cost, based on a cost function as applied to the state of the vehicle, at one of a plurality of points in time; and
performing, via a processor, a search of the lattice solver graph, based on the associated costs of each node of the lattice solver graph, to determine a selected path for the vehicle through the region of interest that minimizes a total cost via the lattice solver graph.

5. The method of claim 4, wherein the lattice solver graph is defined using an acceleration of the vehicle at different future points in time, utilizing a time step, such that different nodes are connected based on the acceleration of the vehicle at the different future points of time following various iterations of the time step.

6. The method of claim 5, further comprising:
ignoring or deleting, from the lattice solver graph, any nodes for which the velocity of the vehicle is less than a predetermined minimum threshold speed or is greater than a predetermined maximum threshold speed.

7. The method of claim 1, wherein the set of selection criteria determines the selected path from the first and second candidate paths based on whether the first and second candidate paths are determined within a predetermined time-out interval.

8. A system for path planning for a vehicle, the system comprising:
a region of interest module, with a processor, configured to determine a region of interest and an intended path of the vehicle based on the sensor data, and determine a set of predicted object paths of one or more objects likely to intersect the region of interest;
a first candidate path determination module that minimizes a first cost function applied to a spatiotemporal decision-point graph constructed based on the predicted object paths;
a second candidate path determination module that minimizes a second cost function applied to a state lattice graph constructed based on the predicted object paths; and
a path selection module configured to determine a selected path from the first and second candidate paths based on a set of selection criteria.

9. The system of claim 8, wherein the first candidate path determination module:
defines, within a spatiotemporal path space associated with the region of interest and a planning horizon, a set of obstacle regions corresponding to the set of predicted paths, and defines a plurality of decision points for each of the obstacle regions;
defines the spatiotemporal decision-point graph based on the plurality of decision points and the first cost function applied to a set of path segments interconnecting the decision points; and
performs a search of the directed graph to determine a selected path.

10. The system of claim 9, wherein the spatiotemporal decision-point graph is defined by providing a directed edge between a first decision point to a second decision point if: the second decision point is subsequent in time to the first vertex; the second decision point corresponds to a greater distance than the first decision point; the directed edge would not pass through one of the obstacle regions; and the directed edge would not exceed a kinematic constraint associated with the vehicle.

11. The system of claim 8, wherein the second candidate path determination module:
defines a lattice solver graph comprising a plurality of nodes, each of the plurality of nodes comprising a state of the vehicle and an associated cost, based on a cost function as applied to the state of the vehicle, at one of a plurality of points in time; and
performs a search of the lattice solver graph, based on the associated costs of each node of the lattice solver graph, to determine a selected path for the vehicle through the region of interest that minimizes a total cost via the lattice solver graph.

12. The system of claim 11, wherein the lattice solver graph is defined using an acceleration of the vehicle at different future points in time, utilizing a time step, such that different nodes are connected based on the acceleration of the vehicle at the different future points of time following various iterations of the time step.

13. The system of claim 12, wherein the second candidate path determination module ignores, in the lattice solver graph, any nodes for which the velocity of the vehicle is less than a predetermined minimum threshold speed or is greater than a predetermined maximum threshold speed.

14. The system of claim 8, wherein the set of selection criteria determines the selected path from the first and second candidate paths based on whether the first and second candidate paths are determined within a predetermined time-out interval.

15. An autonomous vehicle, comprising:
at least one sensor that provides sensor data; and
a controller that is configured, by a processor, based on the sensor data, to:
define, with a processor, a region of interest and an intended path of the vehicle based on the sensor data;
determine a set of predicted object paths of one or more objects likely to intersect the region of interest;
determine a first candidate path that minimizes a first cost function applied to a spatiotemporal decision-point graph constructed based on the predicted object paths;
determine a second candidate path that minimizes a second cost function applied to a state lattice graph constructed based on the predicted object paths; and
determine a selected path from the first and second candidate paths based on a set of selection criteria.

16. The autonomous vehicle of claim 15, wherein determining the first candidate path includes:
defining, within a spatiotemporal path space associated with the region of interest and a planning horizon, a set of obstacle regions corresponding to the set of predicted paths;
defining a plurality of decision points for each of the obstacle regions;
defining the spatiotemporal decision-point graph based on the plurality of decision points and the first cost function applied to a set of path segments interconnecting the decision points; and
performing, with a processor, a search of the directed graph to determine a selected path.

17. The autonomous vehicle of claim 16, wherein defining the spatiotemporal decision-point graph includes providing a directed edge between a first decision point to a second decision point if: the second decision point is subsequent in time to the first vertex; the second decision point corresponds to a greater distance than the first decision point; the directed edge would not pass through one of the obstacle regions; and the directed edge would not exceed a kinematic constraint associated with the vehicle.

18. The autonomous vehicle of claim 17, wherein determining the second candidate path includes:
defining a lattice solver graph comprising a plurality of nodes, each of the plurality of nodes comprising a state of the vehicle and an associated cost, based on a cost function as applied to the state of the vehicle, at one of a plurality of points in time; and
performing, via a processor, a search of the lattice solver graph, based on the associated costs of each node of the lattice solver graph, to determine a selected path for the vehicle through the region of interest that minimizes a total cost via the lattice solver graph.

19. The autonomous vehicle of claim 18, wherein the lattice solver graph is defined using an acceleration of the vehicle at different future points in time, utilizing a time step, such that different nodes are connected based on the acceleration of the vehicle at the different future points of time following various iterations of the time step.

20. The autonomous vehicle of claim 15, wherein the set of selection criteria determines the selected path from the first and second candidate paths based on whether the first and second candidate paths are determined within a predetermined time-out interval.
